(19) United States
(12) Patent Application Publication
(10) Pub. No.: US 2022/0065442 A1
(43) Pub. Date: Mar. 3, 2022

(54) PROCESS FOR PRODUCING STEAM FOR A HYDROCARBON RECOVERY PROCESS

(71) Applicant: Cenovus Energy Inc., Calgary (CA)

(72) Inventor: Paul Edward ST. AMANT, Bonnyville (CA)

(21) Appl. No.: 17/405,386

(22) Filed: Aug. 18, 2021

Related U.S. Application Data
(60) Provisional application No. 63/070,732, filed on Aug. 26, 2020.

(51) Int. Cl. F22B 29/06; E21B 43/24; E21B 43/16

(52) U.S. Cl. CPC F22B 29/06; F22B 1/18; E21B 43/164; E21B 43/2406

(57) ABSTRACT

A process for producing steam for use in a hydrocarbon recovery process includes introducing feed water into a steam generator to produce the steam and a blowdown stream, contacting the blowdown stream from the steam generator with a flue gas including carbon dioxide from the steam generator to absorb at least a portion of the carbon dioxide from the flue gas, and directing the blowdown stream including the portion of the carbon dioxide absorbed from the flue gas, into a disposal well.

### TECHNICAL FIELD

The present invention relates to steam generation for use in a hydrocarbon recovery process and to the treatment of flue gas and blowdown streams produced during steam generation.

### BACKGROUND

Extensive deposits of hydrocarbons exist around the world. Reservoirs of such deposits may be referred to as reservoirs of light oil, medium oil, heavy oil, extra-heavy oil, bitumen, or oil sands, and include large oil deposits in Alberta, Canada. It is common practice to segregate petroleum substances into categories that may be based on oil characteristics, for example, viscosity, density, American Petroleum Institute gravity (° API), or a combination thereof. For example, light oil may be defined as having an ° API≥31, medium oil as having an ° API≥22 and <31, heavy oil as having an ° API≥10 and <22 and extra-heavy oil as having an ° API≤10 (see Santos, R. G., et al. Braz. J. Chem. Eng. Vol. 31, No. 03, pp. 571-590). Although these terms are in common use, references to different types of oil represent categories of convenience, and there is a continuum of properties between light oil, medium oil, heavy oil, extra-heavy oil, and bitumen. Accordingly, references to such types of oil herein include the continuum of such substances, and do not imply the existence of some fixed and universally recognized boundary between the substances.

One thermal method of recovering viscous hydrocarbons in the form of bitumen, also referred to as oil sands, is known as steam-assisted gravity drainage (SAGD). In the SAGD process, pressurized steam is delivered through an upper, horizontal, injection well, also referred to as an injector, into a viscous hydrocarbon reservoir while hydrocarbons are produced from a lower, generally parallel, horizontal, production well, also referred to as a producer, that is near the injection well and is vertically spaced from the injection well. The injection and production wells are situated in the lower portion of the reservoir, with the producer located close to the base of the hydrocarbon reservoir to collect the hydrocarbons that flow toward the base of the reservoir.

The injected steam during SAGD initially mobilizes the hydrocarbons to create a steam chamber in the reservoir around and above the horizontal injection well. The term steam chamber in the context of a SAGD operation is utilized to refer to the volume of the reservoir that is heated to the steam saturation temperature with injected steam, and from which mobilized oil has at least partially drained and been replaced with steam vapor. As the steam chamber expands, viscous hydrocarbons in the reservoir and water originally present in the reservoir are heated and mobilized and move with aqueous condensate, under the effect of gravity, toward the bottom of the steam chamber. The hydrocarbons, the water originally present, and the aqueous condensate are typically referred to collectively as emulsion. The emulsion accumulates and is collected and produced from the production well. The produced emulsion is separated into dry oil for sales and produced water.

The steam that is utilized is generally produced by combustion, for example, utilizing natural gas, to heat a water feed in a steam generator, such as a once through steam generator (OTSG). Combustion in the steam generator produces an exhaust gas, referred to as flue gas. The flue gas includes greenhouse gases that are exhausted to the atmosphere.

Improvements in steam generation and treatment of flue gases are desirable.

### SUMMARY

According to an aspect of an embodiment, there is provided a process for producing steam for use in hydrocarbon recovery. The process includes introducing feed water into a steam generator to produce the steam and a blowdown stream, contacting the blowdown stream from the steam generator with a flue gas including carbon dioxide from the steam generator to absorb at least a portion of the carbon dioxide from the flue gas, and directing the blowdown stream including the portion of the carbon dioxide absorbed from the flue gas, into a disposal well.

According to another aspect, a method of treating flue gas from a steam generator utilized for producing steam for use in a hydrocarbon recovery process is provided. The method includes producing steam and blowdown stream utilizing the steam generator, and contacting the blowdown stream from the steam generator with the flue gas from the steam generator to absorb at least a portion of carbon dioxide from the flue gas and provide a treated flue gas having reduced carbon dioxide content.

According to yet another aspect, a system for producing steam for use in a hydrocarbon recovery process is provided. The system includes a feed water source, a combustible gas source, a steam generator coupled to the feed water source and to the combustible gas source to produce steam from feed water, and a contactor coupled to the steam generator to receive blowdown stream produced from the steam generator and coupled to the steam generator to receive flue gas generated therefrom, for contacting the blowdown stream with the flue gas to absorb at least a portion of carbon dioxide in the flue gas.

### BRIEF DESCRIPTION OF THE DRAWINGS

Embodiments of the present invention will be described, by way of example, with reference to the drawings and to the following description, in which:

FIG. 1 is a simplified sectional view through a reservoir, illustrating a SAGD well pair;

FIG. 2 is a simplified sectional side view illustrating a SAGD well pair including an injection well and a production well;

FIG. 3 is a simplified schematic view illustrating a system for producing steam for use in a hydrocarbon recovery operation in accordance with an aspect of an embodiment;

FIG. 4 is a simplified schematic showing an example of a contactor;

FIG. 5 is a simplified schematic showing another example of a contactor;

FIG. 6 is a flowchart showing a process for producing steam for use in a hydrocarbon recovery operation in accordance with an aspect of an embodiment.

### DETAILED DESCRIPTION

The disclosure generally relates to the production of steam for use in hydrocarbon recovery. A process includes introducing feed water into a steam generator to produce the steam and a blowdown stream, contacting the blowdown stream from the steam generator with a flue gas including carbon dioxide from the steam generator to absorb at least a portion of the carbon dioxide from the flue gas, and directing the blowdown stream including the portion of the carbon dioxide absorbed from the flue gas, into a disposal well.

For simplicity and clarity of illustration, reference numerals may be repeated among the figures to indicate corresponding or analogous elements. Numerous details are set forth to provide an understanding of the examples described herein. The examples may be practiced without these details. In other instances, well-known methods, procedures, and components are not described in detail to avoid obscuring the examples described. The description is not to be considered as limited to the scope of the examples described herein.

Reference is made herein to an injection well and a production well. The injection well and the production well may be physically separate wells. Alternatively, the production well and the injection well may be housed, at least partially, in a single physical wellbore, for example, a multilateral well. The production well and the injection well may be functionally independent components that are hydraulically isolated from each other, and housed within a single physical wellbore.

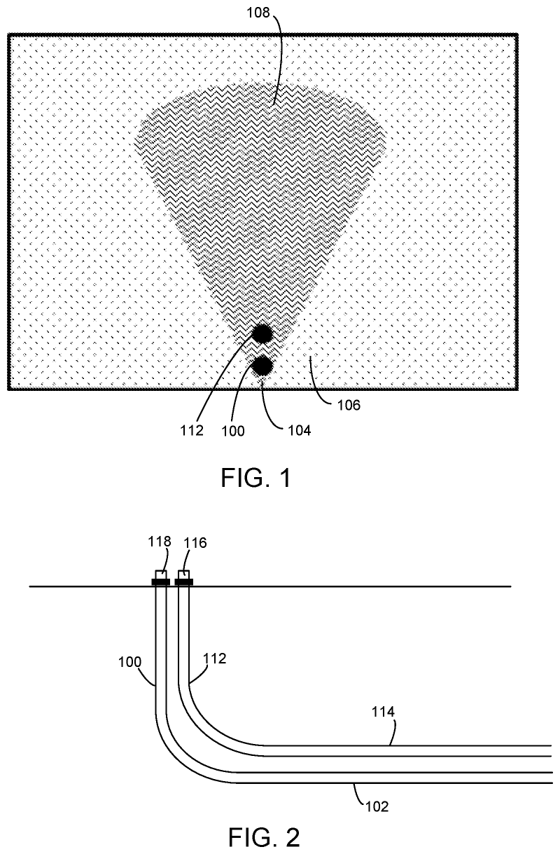

As described above, a steam-assisted gravity drainage (SAGD) process may be utilized for mobilizing viscous hydrocarbons. In the SAGD process, a well pair, including a hydrocarbon production well and a steam injection well are utilized. An example of a well pair is illustrated in FIG. 1 and FIG. 2. The hydrocarbon production well 100 includes a generally horizontal portion 102 that extends near the base or bottom 104 of the hydrocarbon reservoir 106. An injection well 112 also includes a generally horizontal portion 114 that is disposed generally parallel to and is spaced vertically above the horizontal portion 102 of the hydrocarbon production well 100.

During production utilizing SAGD, steam is injected into the injection well head 116 and through the steam injection well 112 to mobilize the hydrocarbons and create a steam chamber 108 in the reservoir 106, around and above the generally horizontal portion 114.

Viscous hydrocarbons in the reservoir 106 are heated and mobilized and the mobilized hydrocarbons drain under the effects of gravity. Fluids, including the mobilized hydrocarbons along with condensate, are collected in the generally horizontal portion 102 and are recovered via the hydrocarbon production well 100. Production may be carried out for any suitable period of time.

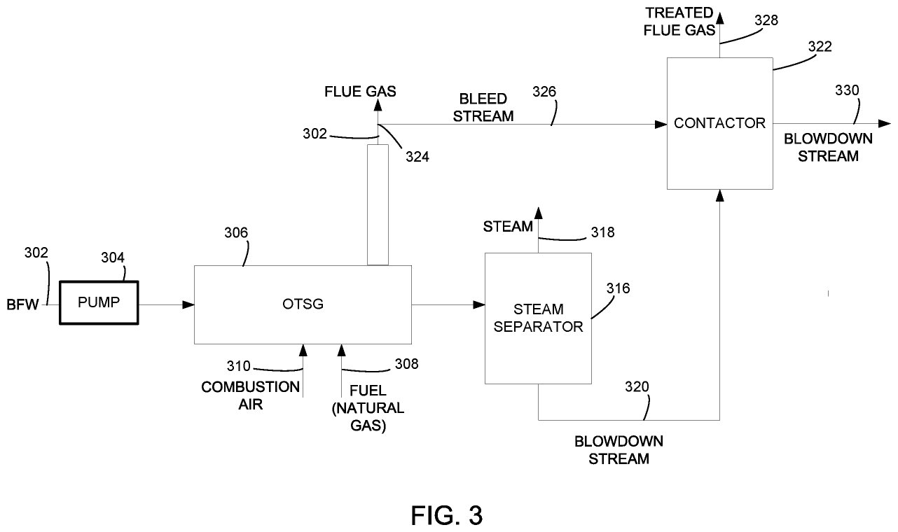

A simplified schematic view illustrating a system for producing the steam for use in the hydrocarbon recovery operation, such as that shown and described with reference to FIG. 1 and FIG. 2, is shown in FIG. 3.

The steam that is injected via the injection well 112 may be generated at least partially from the produced water, for example, recovered from the production well 100. The produced water is de-oiled and softened to provide at least part of the boiler feed water 302. The feed water 302 may include water produced from the hydrocarbon recovery process or, for example, another hydrocarbon recovery process occurring in another reservoir, fresh water, water not previously utilized in the hydrocarbon recovery process, or a combination thereof. The feed water includes impurities such as chlorides and dissolved solids.

A simplified schematic illustrating a system and process for producing steam and for treating the flue gas generated during the production of steam utilized in a hydrocarbon recovery process is shown in FIG. 3. The system may include further elements not show or described herein for the purpose of simplicity.

The feed water 302 is pumped into a steam generator 306, which in the present example is a once through steam generator (OTSG), utilizing a pump assembly 304 to introduce the feed water 302 at high pressure into the steam generator 304. The steam generator 304 includes multiple tubes, referred to as passes, for heat exchange to heat the feed water and generate steam.

A portion of the feed water 302 may come from the produced emulsion from a production well, such as the production well 100, which may be subjected to known separation and degassing techniques, to separate the produced water from hydrocarbons in the emulsion and from produced gas. The produced water from the production well 100 is optionally treated in a de-oiling and water treatment sub-system to remove or reduce oil in the produced water. The de-oiling process may be, for example, a known mechanical de-oiling process followed by oil filtering. Produced water de-oiling may include treatment in a skim tank, an Induced Gas Flotation (IGF) Unit or an Induced Static Flotation (ISF) Unit, and use of an Oil Removal Filter (ORF). The produced water may also be treated in an evaporator, lime softener (e.g., warm lime softener (WLS), hot lime softener), or ion exchange equipment (e.g., Strong Acid Cation (SAC) exchange, Weak Acid Cation (WAC) exchange). The produced water may optionally be subjected to additional treatment processes such as electro-flocculation, column flotation, other oil removal or filtration processes, upset recovery, hydrocyclone treatment, graphene membrane separation processes, capacitive deionization, ceramic membrane filtration, and other processes, or a combination of the above processes.

The steam generator 306 includes an economizer, also referred to as the convective section, for preheating the feed water 302 received from the pump assembly 304, and a radiant section in fluid communication with the economizer section for generating steam from the feed water.

The steam generator 306 utilizes a fuel, such as natural gas 308 and combustion air 310 for combustion to heat the feed water 302 and produces a flue gas 312 which includes, for example between about 8 wt. % and about 10 wt. % carbon dioxide. Assuming complete combustion, methane combustion with 10% excess air, assuming 80% nitrogen and 20% oxygen:

CH₄+2O₂ [symbol] CO₂+2H₂O

(16) g/mol+2(32) g/mol=(44) g/mol+2(18) g/mol
Mass balance by ratio

44 g/mol÷16 g/mol=2.75
Assuming that there is ˜3.2% of CH4_{(g)} entrained in combustion air, which results in about 8.8% CO_{2(g)} entrained in flue gas
Thus, carbon dioxide in the flue gas is about 8.80% by weight.

Fluid 314 from the steam generator 304 flows to a steam separator 316. During a hydrocarbon recovery process, steam is separated from the remaining fluid to produce steam 318. The steam 318 produced from the steam separator 316 is transported via pipeline for injection into the underground reservoir to mobilize the hydrocarbons during hydrocarbon recovery.

The remaining fluid from the steam generator 304, which may be referred to as a blowdown stream 320, has a high pH, generally of about 12. Heat may be recovered from the blowdown stream 320 in a heat exchanger and the blowdown stream 320 is directed to a contactor 322. The flue gas 312 may optionally be split into two streams in a splitter 324, and one of the streams of the flue gas 326 is directed to the contactor 322. The contactor 322 promotes contact between the blowdown stream 320 and the stream of flue gas to absorb a portion of the carbon dioxide from the stream of flue gas 326 into the blowdown stream 320 in the contactor 322.

Although not illustrated, a portion of the blowdown stream may be recycled back to the boiler feed water 302.

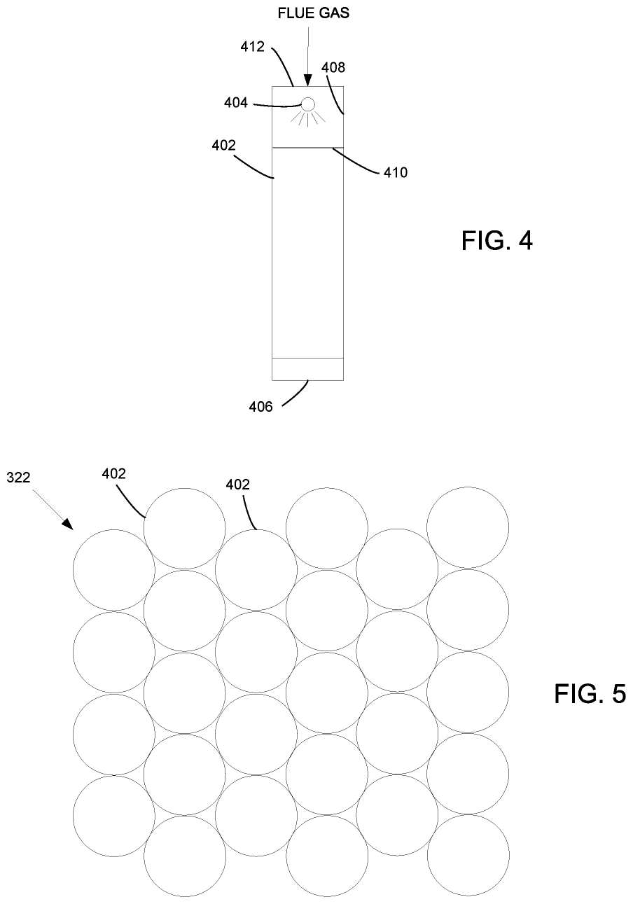

An example of a contactor 322 is illustrated in FIG. 4. In the example shown in FIG. 4, the contactor includes a generally cylindrical column 402, for example, of about 30 cm diameter and 3 to 4 meters in height, that includes a fluid spray nozzle 404 for spraying the blowdown stream 320 into the contactor 322. The contactor 322 may be shaped or include formations along the column to promote turbulent flow of the blowdown stream 320 as the blowdown stream travels through the contactor toward the outlet 406. For example, the contactor 322 may include crests and troughs or an undulating pattern along the inner surface 408 to promote frothing of the blowdown stream. The column 402 may include multiple layers of screens 410 or mesh that the blowdown stream 320 passes through as the blowdown stream travels through the column. The stream of flue gas 326 is introduced via an inlet 412 at the top of the column 402. As the stream of flue gas 326 is pumped into the inlet 412 and through the column 402, pulses of the blowdown stream are introduced at a regular time interval, such as once every 5 seconds. The turbulent flow or frothing generated provides increased surface area of the blowdown stream 320 in contact with the stream of flue gas 326 as the two travel co-currently through the column 402. One example of a suitable contactor is a Regenerative Froth Contactor from Industrial Climate Solutions Inc.

As indicated, the blowdown stream 320 has high pH of, for example, close to 12, suitable for absorption of carbon dioxide. Frothing provides high surface area of the blowdown stream 320 to absorb carbon dioxide to produce carboxylic acid and suspended salts. The pH of the blowdown stream 320 is slightly reduced by the absorption of carbon dioxide to produce carboxylic acid and salts. The blowdown stream 320 may include sodium, calcium, and magnesium, the ions of which contribute to the high alkalinity. The blowdown stream 320 may have a pH of 11 or greater, for example between 11 and 12. Carbon dioxide from the stream of flue gas 326 is dissolved into the blowdown stream 320 as some of the carbon dioxide molecules react with water molecules to form H₂CO₃, carbonic acid. Carbonic acid is a weak acid formed from the dissolving of carbon dioxide in water:

CO₂(g)+H₂O [symbol] H₂CO₃ [symbol] HCO₃⁻+H⁺

The carbonic acid that is formed in the blowdown stream 320 reacts with sodium hydroxide to form sodium bicarbonate:

H₂CO₃+NaOH [symbol] NaHCO₃+H₂O

As the pH is reduced, Sodium bicarbonate reacts with bases such as sodium hydroxide to form carbonates:

NaHCO₃+NaOH [symbol] Na₂CO₃+H₂O.

The carbonic acid is a weak acid and neutralizes basic compounds. With solutions of carbonate (CO₃²⁻) and bicarbonate (HCO₃⁻) ions, carbon dioxide gas is also formed. The carbonic acid also reacts with Ca²⁺ and Mg²⁺ ions, reducing the alkalinity and precipitating CaCO₃ (limestone) or MgCO₃. The blowdown stream 320 has high pH and absorbs CO₂ gas as indicated.

Each hydrocarbon recovery operation may include several steam generators, for example, greater than 20 steam generators. Each steam generator may produce about 25 m³/h to about 33 m³/h blowdown water for disposal. A feed rate of air of about 2500 e³ m³/day and fuel gas of about 215 e³ m³/day. Thus, a very high volume of flue gas is produced per day. An OTSG may produce, for example, over 100,000 kg/hr of flue gas. A hydrocarbon recovery operation including several steam generators may produce, for example, over 400,000 kg/hr flue gas.

Because turbulent flow is generated in the contactor 322, the chance of large growth of precipitates or fouling in the column 402 is low. The turbulence reduces the chance for large growth of precipitates and reduces scaling that may otherwise occur. With the high liquid to gas ratio in the contactor 322, the solids are maintained in suspension in the blowdown stream 320. Solid build up in other areas is possible. For example, solid build up may occur post blowdown stream 320 exiting the contactor 322, for example, in a sump below the contactor 322, or in any other zone in which the flow rate of blowdown stream is reduced or in which there is lower pressure or temperature, which may accelerate precipitation or agglomeration or both.

A single column may be utilized to handle up to, for example 1000 m³/h of flue gas. To accommodate the flow rate of the blowdown stream 320 for contacting with the stream of flue gas 326, the contactor may include more than one column 402. Referring to FIG. 5, a generally closely packed structure 502 made up of several columns 402 is shown. The columns 402 are arranged in the generally closely packed structure 502 to increase the rate of throughput of the flue gas 326, facilitating larger scale treatment than is possible utilizing a single column 402.

The columns 402 may have internal sleeves that are disposed therein and may be lifted out of the columns for servicing, for example, in the event of fouling of the sleeves. Servicing may involve removal of the overhead gas and liquid distribution systems to provide crane access to lift the sleeves out.

The process for producing steam is described herein with reference to FIG. 3 and describing a single steam generator. Numerous steam generators may be utilized to produce steam for a single reservoir. For example, 20 or more steam generators may be utilized. The structure 502 illustrated in FIG. 5 may be utilized to absorb carbon dioxide from flue gas generated by multiple steam generators.

The mass ratio of the blowdown stream 320 to the stream of flue gas 326 in the column is greater than 10:1, for example on the order of about 15:1 to about 20:1. In one example, the blowdown stream 320 may be, for example, 400 m³/h to 650 m³/h. The total flue gas 312 produced is of such a high volume that there may be insufficient blowdown stream 320 to absorb carbon from the total flue gas 312. Thus, the splitter 324 is utilized to treat the stream of the flue gas 326.

The carbon dioxide from the stream of flue gas 326 is absorbed by the blowdown stream 320 to form suspended salts in the high pH post-contactor blowdown stream. The treated flue gas 328, which is reduced in carbon dioxide compared to the stream of flue gas 326 prior to passing through the contactor 322, exits the contactor 322 and may be exhausted to atmosphere or further treated.

The post-contactor blowdown stream 330 is disposed of, for example, by directing the post-contactor blowdown stream 330 into a disposal well. As will be appreciated, a disposal well may be any suitable deep well, including a well in a reservoir or zone that is depleted of recoverable hydrocarbons, or a test well or other well into which waste fluids are injectable.

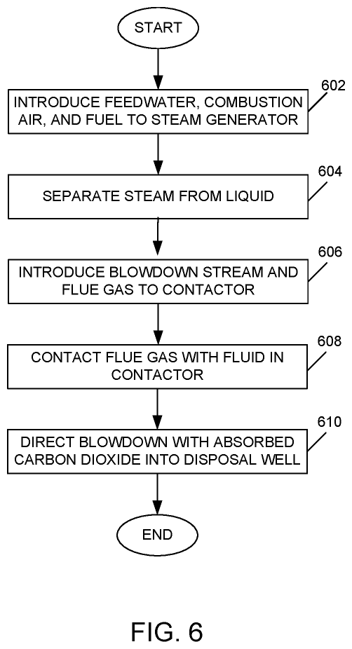

A flowchart illustrating a process for producing steam for use in a hydrocarbon recovery process is illustrated in FIG. 6 and described with continued reference to FIG. 3. The process may include additional or fewer elements than shown and described and parts of the method may be performed in a different order than shown or described herein.

The feed water 302, the fuel, such as natural gas 308, and the combustion air 310 are fed into the steam generator 306 and flue gas 312 is produced at 602.

The fluid 314 from the steam generator 304 is separated into steam 318 and a blowdown stream 320 in a steam separator 316 at 604.

The blowdown stream 320 is directed to the contactor 322 and at least a portion of the flue gas 312, such as the stream of flue gas 326 after splitting, is introduced into the contactor 322 at 606. The stream of flue gas 326 contacts the blowdown stream 320 in the contactor to promote absorption of carbon dioxide from the stream of flue gas 326, into the blowdown stream 320 at 608.

The post-contactor blowdown stream 330 is directed to a disposal well at 610.

The steam generator produces flue gas that includes carbon dioxide. A portion of the carbon dioxide in the flue gas is absorbed into the blowdown stream prior to directing the blowdown stream into a disposal well. Thus, the volume of carbon dioxide exhausted to the atmosphere is reduced by comparison to the volume of carbon dioxide in the flue gas prior to use of the contactor, thereby reducing greenhouse gas emissions. Although not all of the flue gas is treated to absorb carbon dioxide in to the blowdown stream, the volume of flue gas produced and treated and the total carbon dioxide removed from the flue gas results in a significant reduction in greenhouse gas emissions. Advantageously, the carbon dioxide is absorbed in a stream that is directed to a disposal well, effectively disposing of a portion of the greenhouse gases produced by the steam generator.

The described embodiments are to be considered in all respects only as illustrative and not restrictive. The scope of the claims should not be limited by the preferred embodiments set forth in the examples, but should be given the broadest interpretation consistent with the description as a whole. All changes that come with meaning and range of equivalency of the claims are to be embraced within their scope.

1. A process for producing steam for use in a hydrocarbon recovery process, the process comprising:
introducing feed water into a steam generator to produce the steam and a blowdown stream;
contacting the blowdown stream from the steam generator with a flue gas including carbon dioxide from the steam generator to absorb at least a portion of the carbon dioxide from the flue gas; and
directing the blowdown stream including the portion of the carbon dioxide absorbed from the flue gas, into a disposal well.

2. The process according to claim 1, wherein contacting the blowdown stream from the steam generator with the flue gas comprises creating turbulent flow of the blowdown stream and contacting the turbulent flow of blowdown stream with the flue gas.

3. The process according to claim 2, wherein the turbulent flow of blowdown stream and the flue gas flow co-currently in a contactor.

4. The process according to claim 3, wherein contacting the blowdown stream from the steam generator with the flue gas comprises frothing the blowdown stream during co-current flow of the blowdown stream with the flue gas.

5. The process according to claim 3, wherein a mass ratio of the blowdown stream to the flue gas in the contactor is greater than 10:1.

6. The process according to claim 1, comprising splitting the flue gas into a first stream and a second stream and wherein contacting the blowdown stream from the steam generator with the flue gas comprises contacting the blowdown stream with the first stream.

7. The process according to claim 6, wherein only the first stream of the first stream and the second stream, is subjected to contacting with the blowdown stream from the steam generator.

8. A method treating flue gas from a steam generator utilized for producing steam for use in a hydrocarbon recovery process, the method comprising:
producing steam and blowdown stream utilizing the steam generator; and
contacting the blowdown stream from the steam generator with the flue gas from the steam generator to absorb at least a portion of carbon dioxide from the flue gas and provide a treated flue gas having reduced carbon dioxide content.

9. The method according to claim 8, comprising directing the blowdown including the portion of the carbon dioxide absorbed from the flue gas, into a disposal well.

10. The method according to claim 8, wherein contacting the blowdown stream from the steam generator with the flue gas comprises creating turbulent flow of the blowdown stream and contacting the turbulent flow of blowdown stream with the flue gas.

11. The method according to claim 10, wherein the turbulent flow of blowdown stream and the flue gas flow co-currently in a contactor.

12. The method according to claim 10, wherein contacting the blowdown stream from the steam generator with the flue gas comprises frothing the blowdown stream during co-current flow of the blowdown stream with the flue gas.

13. The method according to claim 11, wherein a mass ratio of the blowdown stream to the flue gas in the contactor is greater than 10:1.

14. The method according to claim 8, comprising splitting the flue gas into a first stream and a second stream and wherein contacting the blowdown stream from the steam generator with the flue gas comprises contacting the blowdown stream with the first stream.

15. The method according to claim 14, wherein only the first stream of the first stream and the second stream, is subjected to contact with the blowdown stream from the steam generator.

16. A system for producing steam for use in a hydrocarbon recovery process, the system, comprising:
a feed water source;
a combustible gas source;
a steam generator coupled to the feed water source and to the combustible gas source to produce steam from feed water; and
a contactor coupled to the steam generator to receive blowdown stream produced from the steam generator and coupled to the steam generator to receive flue gas generated therefrom, for contacting the blowdown stream with the flue gas to absorb at least a portion of carbon dioxide in the flue gas.

17. The system according to claim 16, wherein the steam generator comprises a once-through steam generator (OTSG).

18. The system according to claim 16, wherein the contactor is coupled to a disposal well for disposal of the blowdown stream including the portion of the carbon dioxide absorbed from the flue gas, into the disposal well.

19. The system according to claim 16, wherein the contactor is configured to generate turbulent flow of the blowdown stream for contact with the flue gas.

20. The system according to claim 19, wherein the contactor is configured for co-current flow of the blowdown stream and the flue gas.

21. The system according to claim 20, wherein the contactor is configured to generate frothing of the blowdown stream during co-current flow of the blowdown stream with the flue gas.

22. The system according to claim 20, wherein the contactor is configured to receive a mass ratio of the blowdown stream to the flue gas of greater than 10:1.

23. The system according to claim 16, comprising a splitter coupled to the steam generator and to the contactor for splitting the flue gas into a first stream and a second stream and wherein the contactor is coupled to the splitter to receive the first stream of flue gas for contacting the blowdown stream with the first stream of flue gas.

24. The system according to claim 23, wherein the splitter is coupled to the contactor to direct only the first stream to the contactor.
